(19) United States
(12) Patent Application Publication
(10) Pub. No.: US 2015/0239397 A1
(43) Pub. Date: Aug. 27, 2015

(54) Driver Protection Cameras with Motion Activation and Beacon Locator

(71) Applicant: Anthony E. Smith, SR., Marianna, FL (US)

(72) Inventor: Anthony E. Smith, SR., Marianna, FL (US)

(21) Appl. No.: 14/557,182

(22) Filed: Dec. 1, 2014

Related U.S. Application Data
(60) Provisional application No. 61/944,852, filed on Feb. 26, 2014.

(51) Int. Cl. B60R 1/00; H04N 5/232; H04N 5/77

(52) U.S. Cl. CPC B60R 1/00; H04N 5/77; H04N 5/23203; B60R 2300/406; B60R 2300/404

(57) ABSTRACT

A camera system used to record audio/video data includes an internal visual recording unit, an external visual recording unit, a remote control, and a remote data storage device. The internal visual recording unit and the external visual recording unit are controlled by the remote control. Both the internal visual recording unit and the external visual recording unit each have a camera that is used to record audio/video data. The remote control contains a microphone for specifically recording audio. All recorded audio/video data is transferred to the remote data storage device wirelessly. Additionally, both the internal visual recording unit and the external visual recording unit each contain a beacon locator. Data from the beacon locator are also transferred to the remote data storage device.

The current application claims a priority to the U.S. Provisional Patent application Ser. No. 61/944,852 filed on Feb. 26, 2014.

### FIELD OF THE INVENTION

The present invention relates generally to a camera system activated with motion detection. More specifically, the present invention records video and audio which can be used as evidence for a victim of injustice.

### BACKGROUND OF THE INVENTION

As experienced in the recent past, there is an alarming increase in crime rates throughout the United States and the entire world in general. The increase can be attributed to the increasing gap between the rich and the poor and also the increased number of uneducated individuals. The crimes commonly vary from verbal abuse to personal injury. On most occasions, justice is served to the victim only if the victim has enough evidence to prove the crime or wrongdoing beyond a reasonable doubt. Since an individual becomes a victim of a crime unexpectedly, and also because crimes happen within a short time interval, gathering sufficient evidence is not always possible. The lack of evidence can be very disadvantageous especially during a court hearing.

Governmental departments such as the police are responsible in enforcing regulations within a community. Such law enforcing agencies are designated to assist a citizen in times of injustice. For instance, if a theft has taken place, the police are responsible for punishing the thief and bringing justice to the victim. However, the justice system is not able to fully carry out its responsibilities. In particular, the officials fail to fulfill their responsibilities, or a citizen becomes a victim as a result of the law enforcing officer's fault. The latter occurrence is especially detrimental for a citizen, since the citizen needs to contend with the law in order to punish a person working as a law enforcer. In such instances, the lack of evidence significantly works against the victim.

Based on recent publications on social media, many drivers have been victims of the irresponsible actions of law enforcement officials. More specifically, law enforcement officials seem to abuse their authority when stopping and arresting drivers. As an example, some drivers are apprehended unlawfully during a routine traffic stop. In such instances, the basic human rights of the driver are violated regardless of the driver being guilty or not of the accused crime. When driving related violations are heard in court, it is the evidence the law enforcement officer has to offer against the evidence the driver has to offer. In most cases, the driver is bound to lose due to the lack of evidence.

The use of mobile phones to capture a significant event has widely gained momentum in the past few years. The use of mobile phones along with social media has helped in bringing attention to a variety of events such as protests, crimes, and forceful arrests. However, it may not be convenient for a victim or any other individual to use a mobile phone to capture an event at all times. Even if the event was captured on a mobile phone, the law enforcement officer or any other person related to the violation can force the victim to delete the file or confiscate the mobile phone. As a result, the victim will be left with no evidence to bring forward the true nature of the event.

The objective of the present invention is to address the aforementioned issues. More specifically, the present invention is a camera system that can be used by a victim in order to gather sufficient evidence to prove his or her innocence. In order to gather information, the present invention utilizes an interconnected camera system to record both audio and video. In order to prevent the evidence from being confiscated, the present invention stores the recorded data in an external location. The effective design also allows the user to utilize the present invention in daily activities as well. For instance, the present invention can be utilized to record a child's movements within a certain area. By utilizing the present invention, the user is guaranteed to have audio/video data regarding an incident in the vicinity of the present invention. Such audio/video data is beneficial when dealing with law enforcement officials and also for personal use.

### BRIEF DESCRIPTION OF THE DRAWINGS

FIG. 1 is a block diagram illustrating the basic overall functionality of the present invention.

FIG. 2 is a perspective view of the internal visual recording unit of the present invention.

FIG. 3 is a rear view of the internal visual recording unit of the present invention.

FIG. 4 is a perspective view of the remote control of the present invention.

FIG. 5 is a perspective view of the external visual recording unit of the present invention.

FIG. 6 is a perspective view of the remote data storage device of the present invention.

FIG. 7 is an illustration of the internal visual recording unit being attached with a clamp.

FIG. 8 is an illustration of the external visual recording unit being attached with the external detachable mount.

FIG. 9 is an illustration of the external visual recoding unit, wherein the external visual recording unit is utilized independently.

FIG. 10 is an illustration of the external visual recording unit being attached to the user.

FIG. 11 is another illustration of the external visual recording unit being attached to the user.

FIG. 12 is an illustration of the functionality of the external visual recording unit, wherein the external visual recording unit is utilized independently.

FIG. 13 is another illustration of the functionality of the external visual recording unit.

FIG. 14 is a block diagram illustrating the internal connections within the internal visual recording unit and the external visual recording unit.

FIG. 15 is a block diagram illustrating the internal connections within the remote control.

FIG. 16 is a block diagram illustrating the internal connections within the remote data storage device.

### DETAIL DESCRIPTIONS OF THE INVENTION

All illustrations of the drawings are for the purpose of describing selected versions of the present invention and are not intended to limit the scope of the present invention.

The present invention is a camera system that can be used to collect audio/video data. The present invention is especially beneficial to drivers when they undergo street harassment or injustice by a law enforcing official. More specifically, a victim can present the stored audio/video as evidence when the need arises.

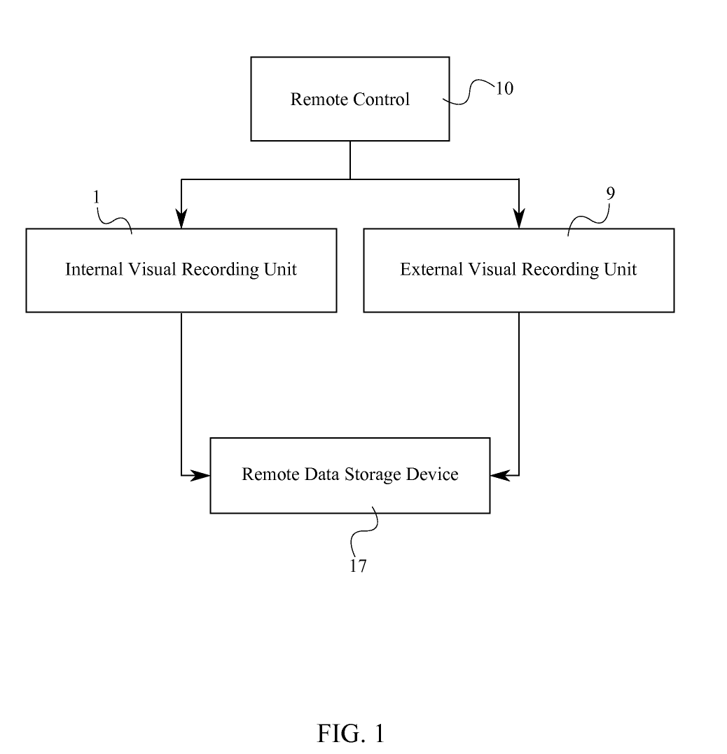

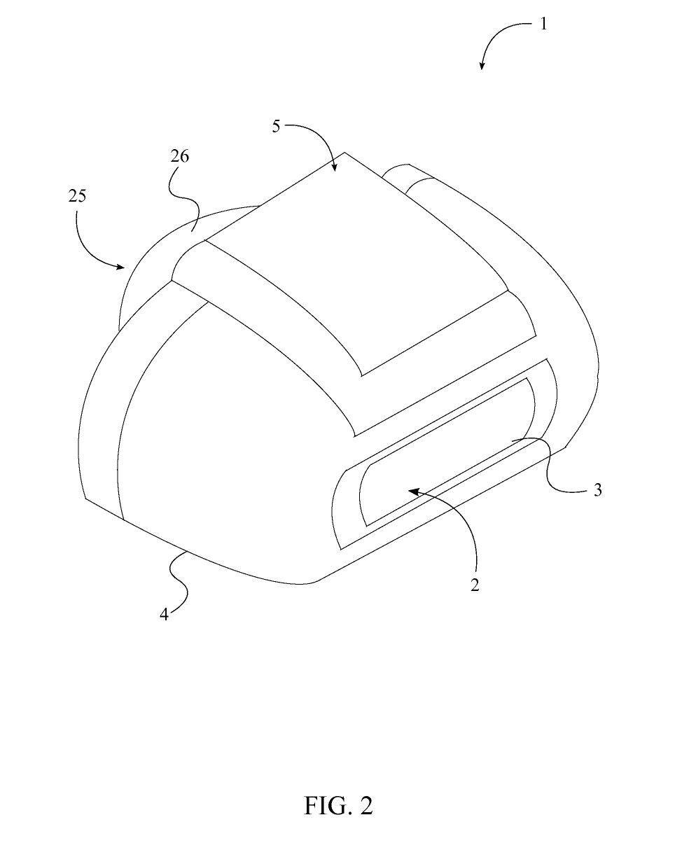

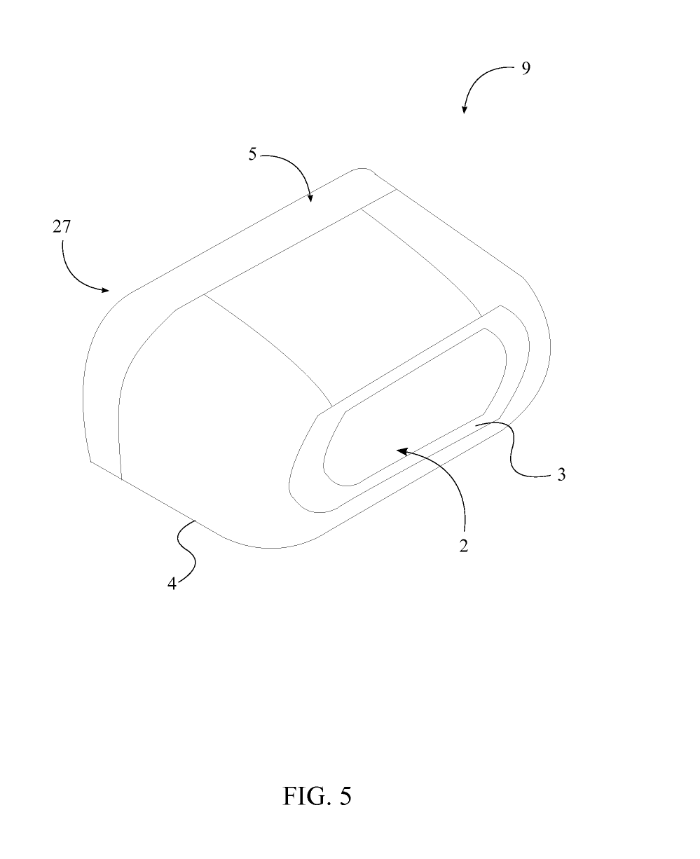

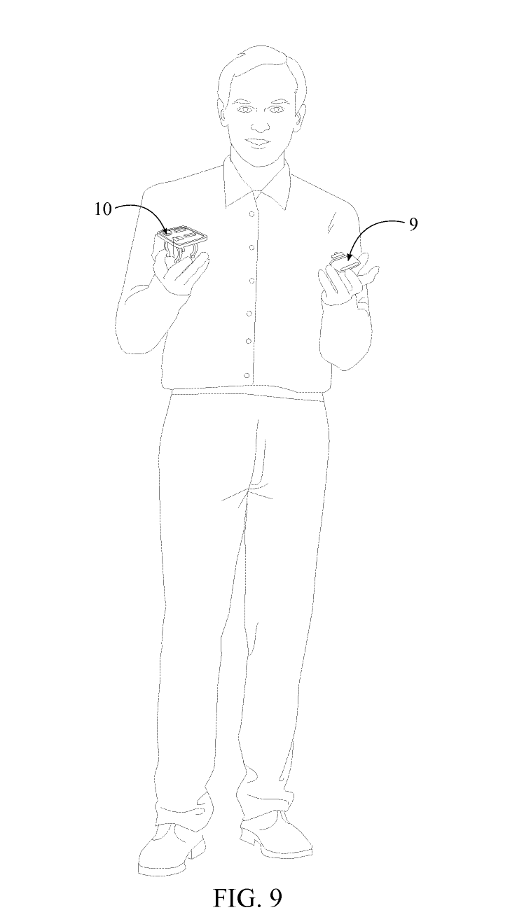

As seen in FIGS. 1-6, the present invention comprises an internal visual recording unit 1, an external visual recording unit 9, a remote control 10, and a remote data storage device 17. In its preferred embodiment, the present invention is intended to be used by drivers. In such instances, the internal visual recording unit 1 gathers audio/video data in the immediate vicinity of the driver of the vehicle. The external visual recording unit 9 records audio/video data in the immediate vicinity of the exterior of the vehicle. As illustrated in FIGS. 9-13, the user controls the functions of the internal visual recording unit 1 and the external visual recording unit 9 through the remote control 10. In order to do so, the remote control 10 is generally within reachable distance to the user. The present invention is designed such that the recorded audio/video data is secured even if the user loses possession of the internal visual recording unit 1 and the external visual recording unit 9. More specifically, the audio/video data is stored in the remote data storage device 17 such that the recorded audio/video data is saved separately.

As mentioned earlier, the internal visual recording unit 1 and the external visual recording unit 9 records audio/video data. In order to do so, the internal visual recording unit 1 and the external visual recording unit 9 each comprises a camera 2, a unit housing 4, a motion detection unit 5, a unit beacon locator 6, a processing unit 7, and a wireless transceiver 8. The camera 2 is used to capture the events in the vicinity of the present invention. If the present invention is on a vehicle, the camera 2 of the internal visual recording unit 1 captures events inside the vehicle. The camera 2 of the external visual recording unit 9 captures events around the vehicle. In order to expand the range that can be captured, the camera 2 comprises a wide view lens 3. As a result, the camera 2 can capture events in a larger area compared to another camera with a standard lens. The wide view lens 3 is integrated into the unit housing 4. Additionally, the unit housing 4 is also utilized to position the remaining components of the internal visual recording unit 1 and the external visual recording unit 9. More specifically, the camera 2, the wireless transceiver 15, the motion detection unit 5, and the processing unit 7 are positioned within the unit housing 4. The internal components of the internal visual recording unit 1 and the external visual recording unit 9 are powered through a power source that can be, but is not limited to, a battery. Moreover, the power source is also positioned within the unit housing 4.

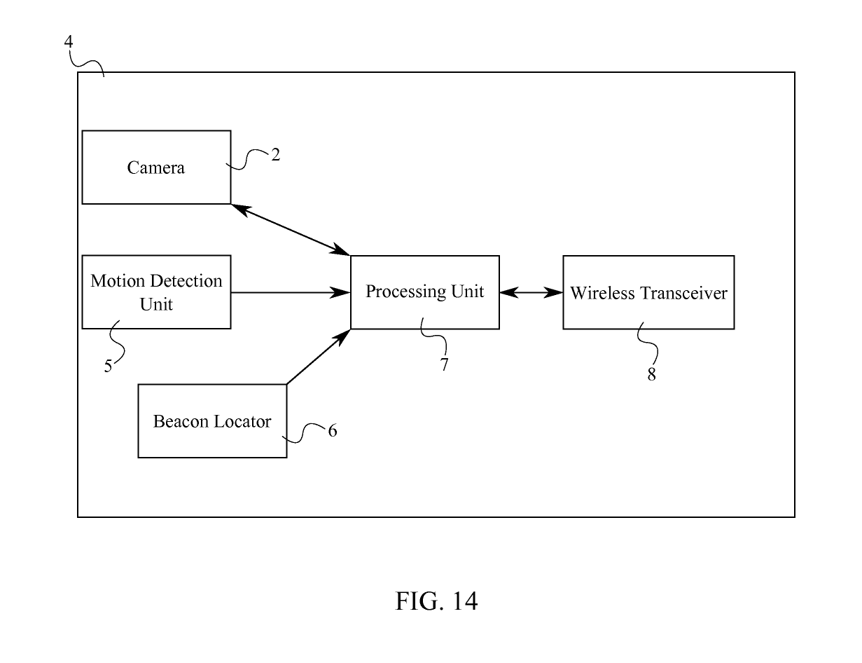

As illustrated in FIG. 14, the internal components of both the internal visual recording unit 1 and the external visual recording unit 9 are function together to capture audio/video data. The camera 2 is electronically connected to the processing unit 7. As a result, all audio/video data captured by the camera 2 is processed at the processing unit 7 prior to storing on the remote data storage device 17. In addition, the motion detection unit 5 is also electronically connected to the processing unit 7. As a result, the camera 2 is triggered to capture events only if the motion detection unit 5 detects significant activity. For instance, the motion detection unit 5 can be designed to be activated when a certain subject is at a predetermined distance from the camera 2. As mentioned before, the data gathered through the internal visual recording unit 1 and the external visual recording unit 9 is stored separately on the remote data storage device 17. The wireless transceiver 8 transfers data from the processing unit 7 to the remote data storage device 17. In order to do so, the wireless transceiver 8 is electronically connected to the processing unit 7. Wireless methods such as, but not limited to, Wi-Fi and Bluetooth, can be used to transfer data from the wireless transceiver 8 to the remote data storage device 17. In order to do so, the internal visual recording unit 1 and the external visual recording unit 9 are communicably coupled to the remote data storage device 24 as shown in FIG. 1. In addition to the audio/video data, the wireless transceiver 15 also transmits data from the unit beacon locator 6. In order to do so, the unit beacon locator 6 is also electronically connected to the processing unit 7 and positioned within the unit housing 4. The unit beacon locator 6 is beneficial in providing corresponding coordinates to the audio/video data received from the camera 2. As a result, the user can present not only the saved audio/video data of the respective event, but also the exact coordinates of the event.

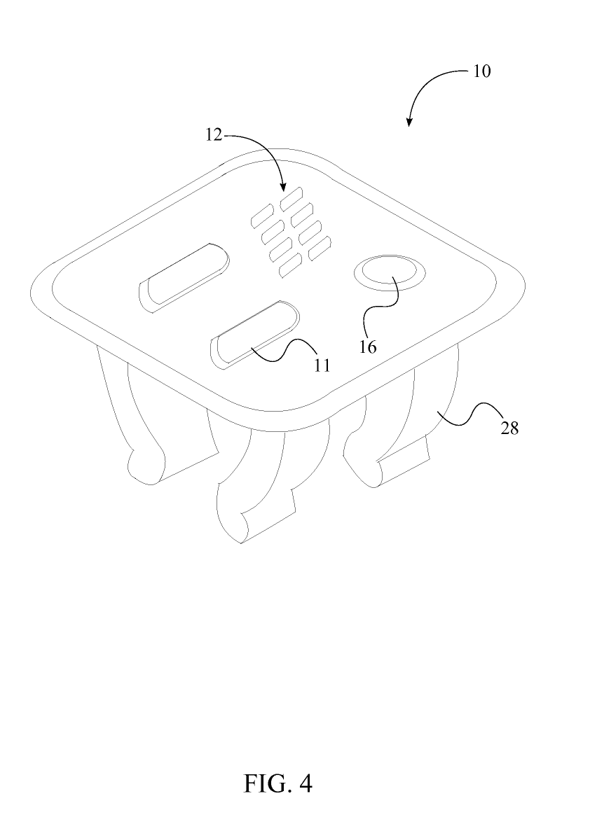

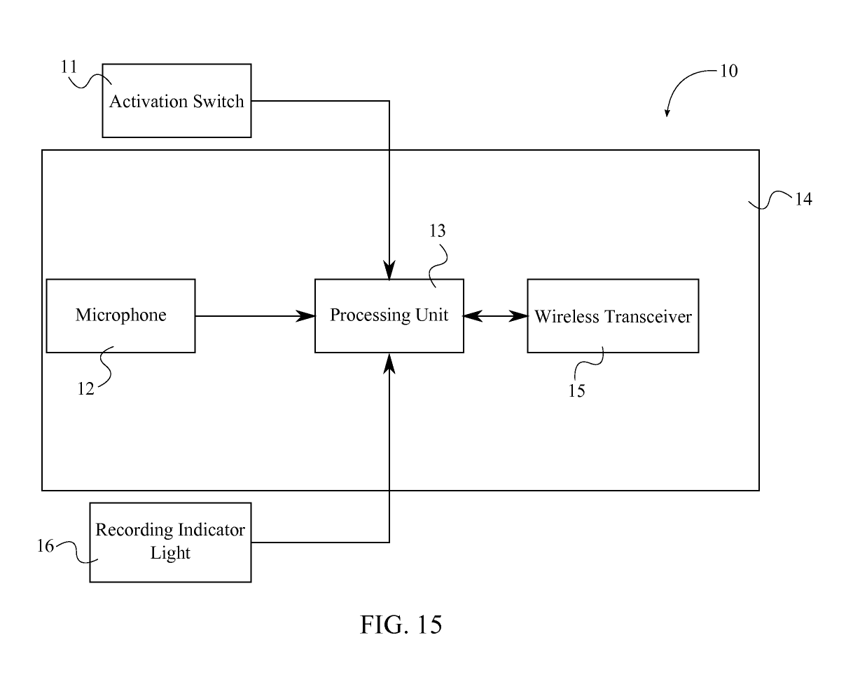

The remote control 10 is illustrated in FIG. 4 and FIG. 15. As mentioned earlier, the remote control 10 controls the internal visual recording unit 1 and the external visual recording unit 9. In order to do so, remote control 10 comprises an activation switch 11, a microphone 12, a processing unit 13, a controller housing 14, a wireless transceiver 15, and a recording indicator light 16. For easy access, the activation switch 11 is positioned onto the controller housing 14. The user activates or deactivates the internal visual recording unit 1 and the external visual recording unit 9 through the activation switch 11. In order to do so, the remote control 10 is communicably coupled to the internal visual recording unit 1, the external visual recording unit 9, and the remote data storage device 17 as illustrated in FIG. 1.

FIG. 15 illustrates the electronic connections within the remote control 10. As illustrated, the activation switch 11 is electronically connected to the processing unit 13. As a result, when the user sends in a command through the activation switch 11, the command is initially transferred to the processing unit 13. Next, the command is transferred from the wireless transceiver 15 to the internal visual recording unit 1, the external visual recording unit 9, or the remote data storage device 17. In order to do so, the wireless transceiver 15 of the remote control 10 is electronically connected to the processing unit 13 of the remote control 10. Additionally, the microphone 12 is also electronically connected to the processing unit 13. Therefore, when the user transfers a command through the activation switch 11, the microphone 12 is also activated. For instance, when the camera 2 is activated through the activation switch 11, the microphone 12 is also simultaneously switched on. The microphone 12 is specifically used to record audio. The recorded audio data is transferred to the remote data storage device 17 via a wireless data transfer method. The processing unit 13, the wireless transceiver 15, and the microphone 12 are all positioned within the controller housing 14. A power source such as, but is not limited to, a battery, is used to provide power to the remote control 10. In such instances, the power source is also positioned within the controller housing 14. When the internal visual recording unit 1 and the external visual recording unit 9 starts recording audio/video data, the recording indicator light 16 illuminates notifying the user that the camera 2 is active. The recording indicator light 16 is electronically connected to the processing unit 13 such that the recording indicator light 16 is activated in conjunction with the internal visual recording unit 1 and the external visual recording unit 9. In order to view the recording indicator light 16 with minimum obstruction, the recording indicator light 16 is positioned onto the controller housing 14.

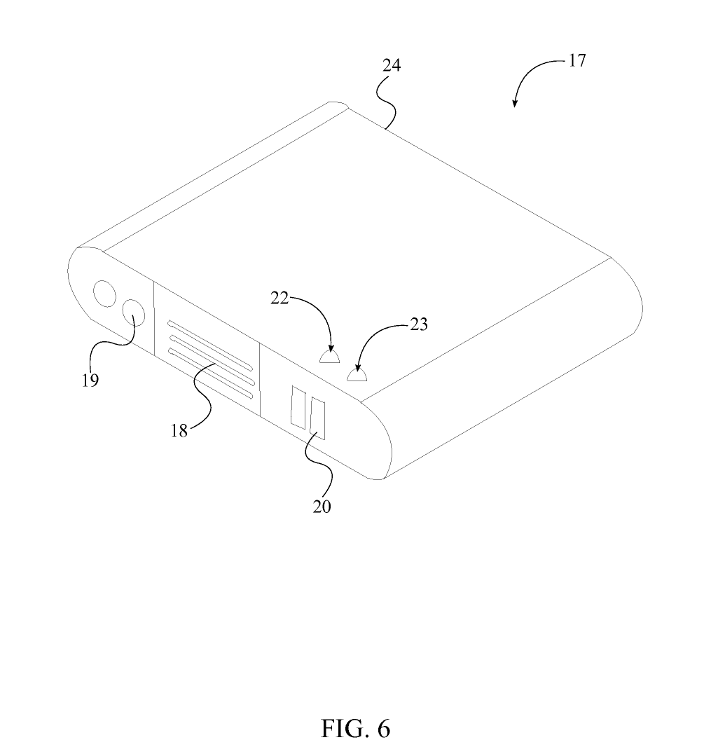

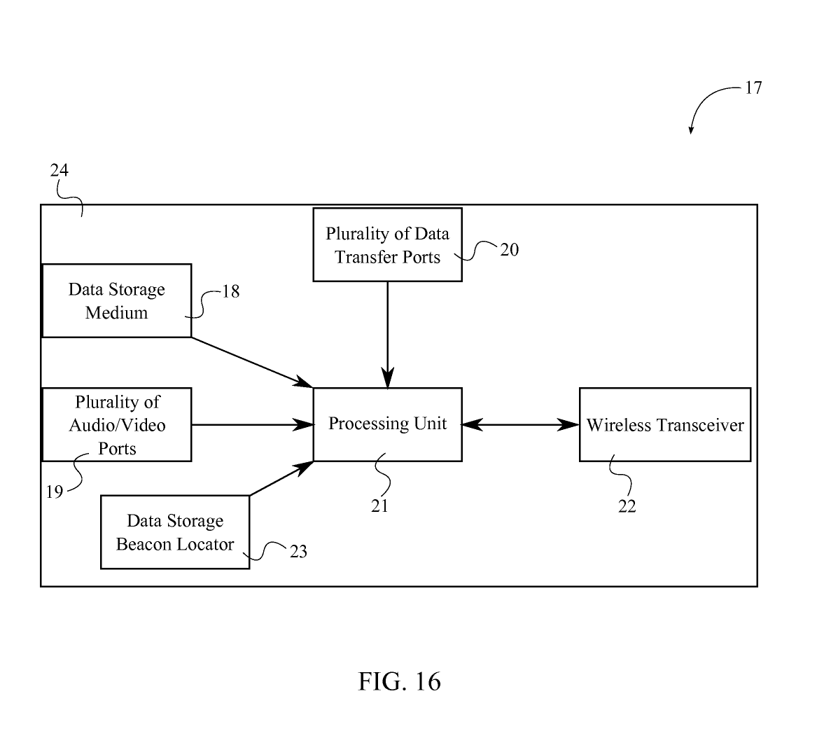

The remote data storage device 17 is illustrated in FIG. 6 and FIG. 16. In the preferred embodiment of the present invention, the remote data storage device 17 comprises a data storage medium 18, a plurality of audio/video ports 19, a plurality of data transfer ports 20, a processing unit 21, a wireless transceiver 22, a data storage beacon locator 23, and a storage system housing 24. The data received from the internal visual recording unit 1 and the external visual recording unit 9 is stored in the data storage medium 18. In the preferred embodiment of the present invention, a plurality of Secure Digital (SD) cards is used to store data. However, in another embodiment of the present invention, a similar medium such as a hard drive can also be used as the data storage medium 18. When the remote data storage device 17 receives data, the wireless transceiver 22 receives the data and transfers the data to the data storage medium 18 through the processing unit 21. In the preferred embodiment of the present invention, the received data is stored in the plurality of SD cards. In order to do so, the data storage medium 18 is electronically connected to the processing unit 21. Similarly, the wireless transceiver 22 is also electronically connected to the processing unit 7 in order to complete the data transfer process.

As mentioned earlier, both the internal visual recording unit 1 and the external visual recording unit 9 comprise the unit beacon locator 6. The data storage beacon locator 23 is utilized to correspond with the unit beacon locator 6 of the internal visual recording unit 1 and the unit beacon locator 6 of the external visual recording unit 9. As a result, accurate coordinates of an event can be obtained. In order to communicate with the unit beacon locator 6, the data storage beacon locater 23 is electronically connected to the processing unit 21. As a result, accurate location information can be provided along with audio/video evidence of a certain incident.

As illustrated in FIG. 6, the plurality of audio/video ports 19 and the plurality of data transfer ports 20 are positioned onto the storage system housing 24. As a result, the user can conveniently transfer data between the remote data storage device 17 and an external storage system such as a computer. However, the remote data storage device 17 can also be designed such that data can be transferred through the wireless transceiver 22. In order to complete the data transfer process, the plurality of audio/video ports 19 is electronically connected to the processing unit 21. Similarly, the plurality of data transfer ports 20 is also electronically connected to the processing unit 21. In order to provide user convenience and mobility, the data storage medium 18 and the processing unit 21 are positioned within the storage system housing 24. As further illustrated in FIG. 6, the storage system beacon locator 23 and the wireless transceiver 22 are positioned onto the storage system housing 24. The electronic connections within the remote data storage device 17 are illustrated in FIG. 16. In the preferred embodiment of the present invention, the remote data storage device 17 is designed to be powered through the cigarette lighter receptacle of the vehicle. However, in another embodiment of the present invention, the remote data storage device 17 can be powered through a different power source that can be, but is not limited to, a battery.

The effective design of the present invention allows the user to use the present invention for many activities as illustrated in FIGS. 9-13. In order to do so, certain components of the present invention require mobility. More specifically, the external visual recording unit 9 and the remote control 10 are designed to be mobile in the preferred embodiment of the present invention.

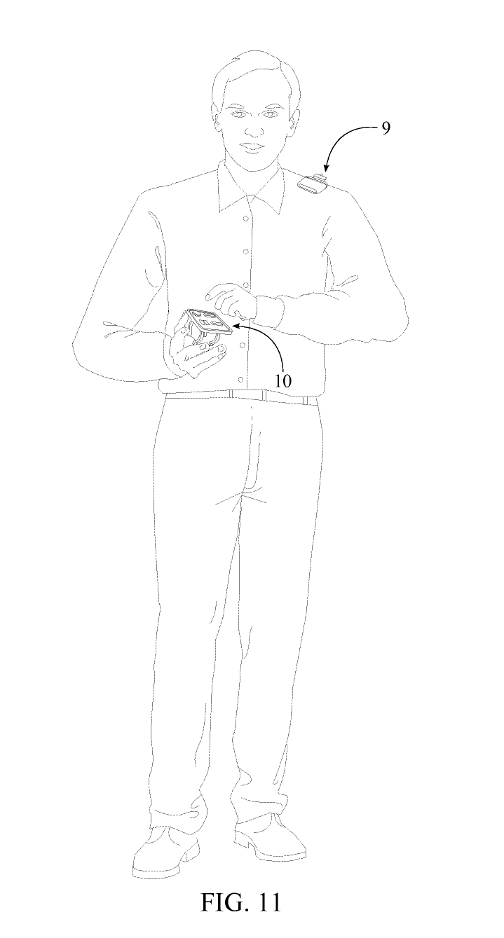

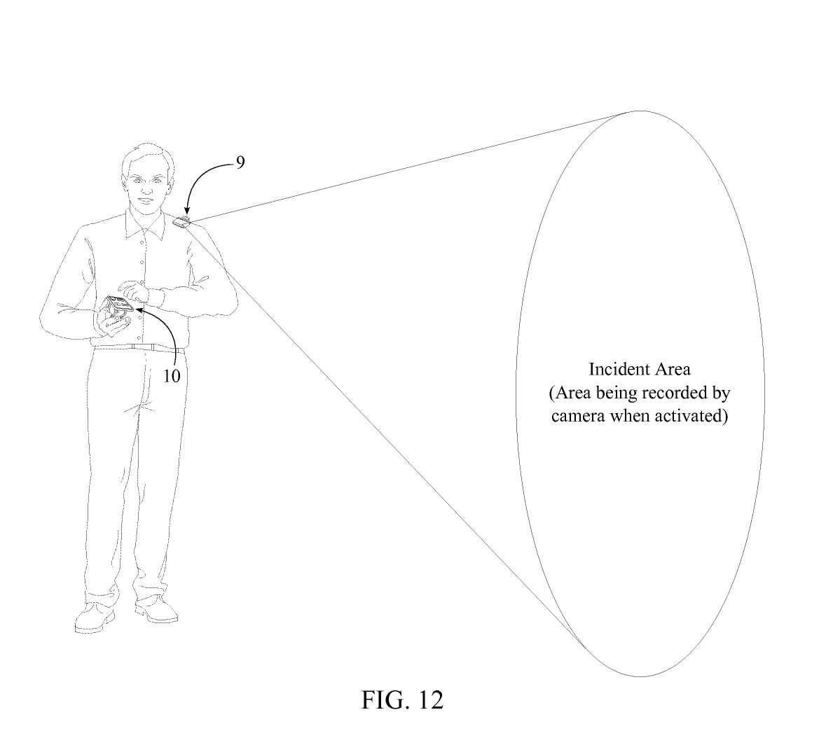

In the preferred embodiment of the present invention, the remote control 10 is designed to be removably attached to the steering wheel of a vehicle. In order to do so, the present invention comprises a C-shaped bracket 28 as illustrated in FIG. 4. The remote control 10 is adjacently connected to the C-shaped bracket 28. Therefore, when the user intends to remove the remote control 10, the user can expand the C-shaped bracket 28 such that the remote control 10 is conveniently removed from the steering wheel. As seen in FIG. 11 and FIG. 12, the C-shaped bracket 28 can also be used as a handle when it is not attached to the steering wheel of the vehicle.

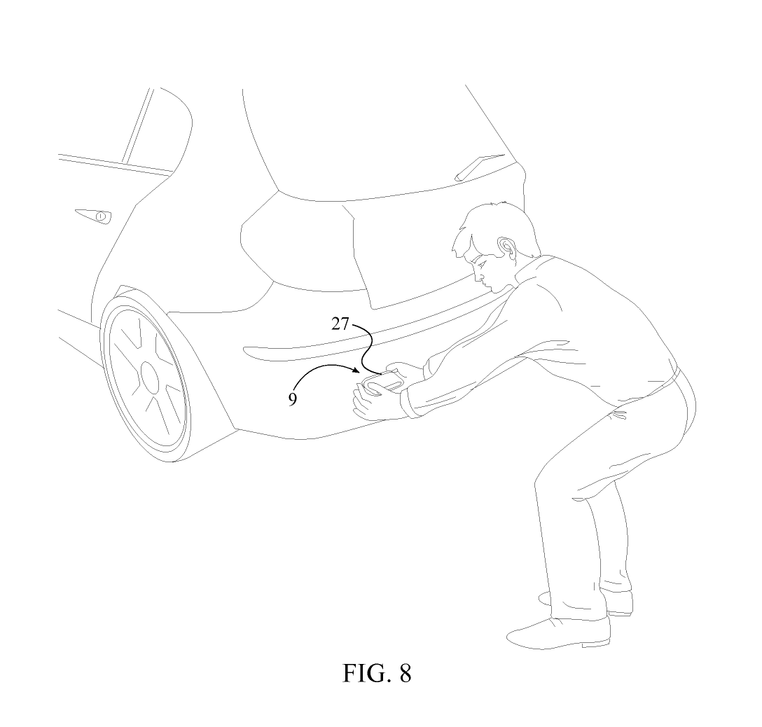

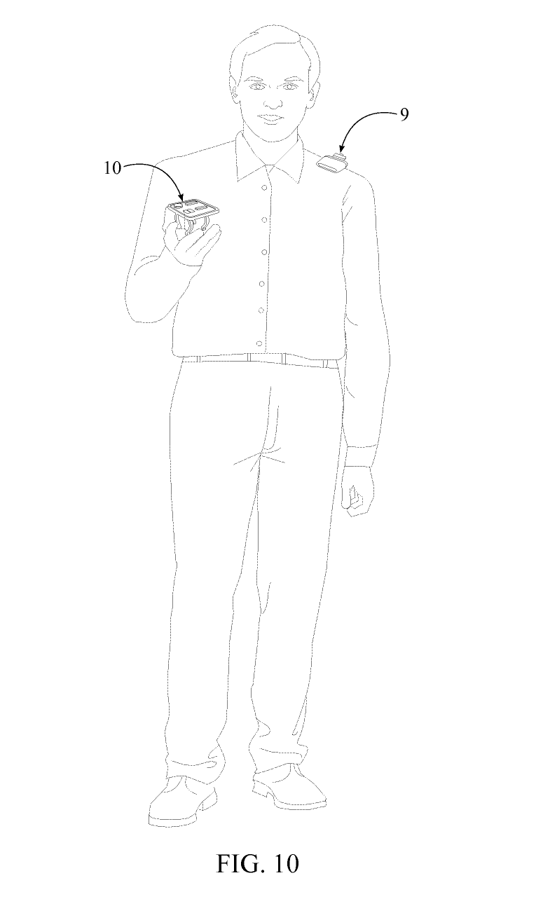

As illustrated in FIG. 12, the external visual recording unit 9 is designed as a mobile visual recording unit. In order to do so, the present invention comprises an external detachable mount 27. The external visual recording unit 9 is adjacently connected to the external detachable mount 27. In the preferred embodiment of the present invention, the external detachable mount 27 is made of a magnetic material. As a result, the external visual recording unit 9 can be attached to the bumper of a vehicle or any other functional position as illustrated in FIG. 8. In addition to the magnetic material, the external detachable mount 27 also allows the external visual recording unit 9 to attach to different surfaces as illustrated in FIG. 10 and FIG. 11.

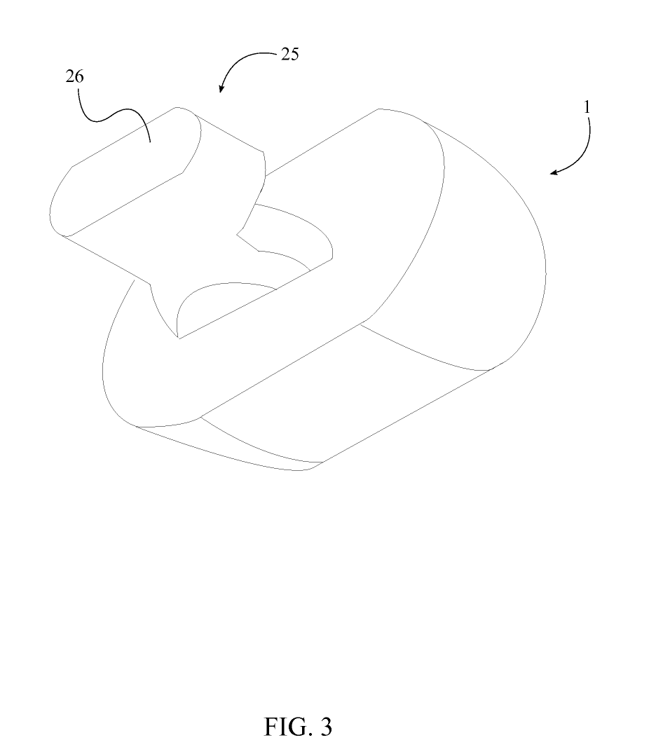

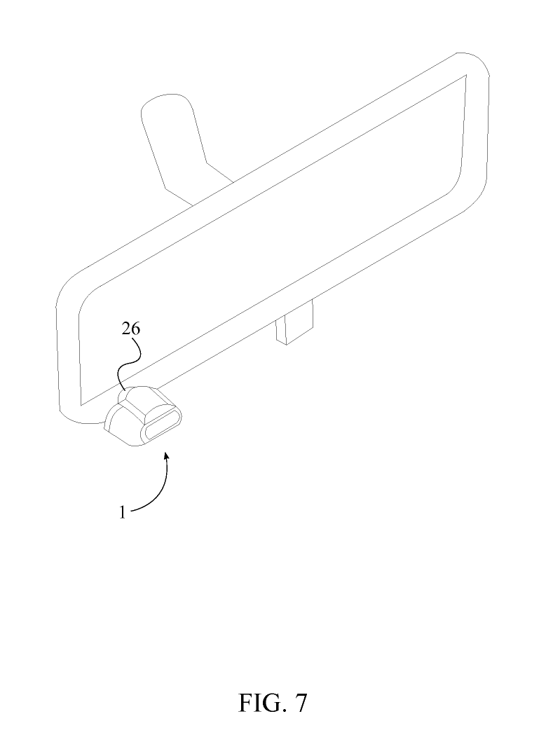

The present invention comprises an internal detachable mount 25. The internal detachable mount 25 secures the internal visual recording unit 1. In order to do so, the internal visual recording unit 1 is adjacently connected to the internal detachable mount 25. As seen in FIG. 7, the internal visual recording unit 1 is secured onto the rearview mirror in the preferred embodiment of the present invention. In order to do so, a clamp 26 is used as the internal detachable mount 25 as illustrated in FIG. 3. The clamp 26 allows the user to turn the internal visual recording unit 1 in a desired direction such that data in a wide range can be recorded through the camera 2. In another embodiment of the present invention, the internal visual recording unit 1 can be positioned in another functional position.

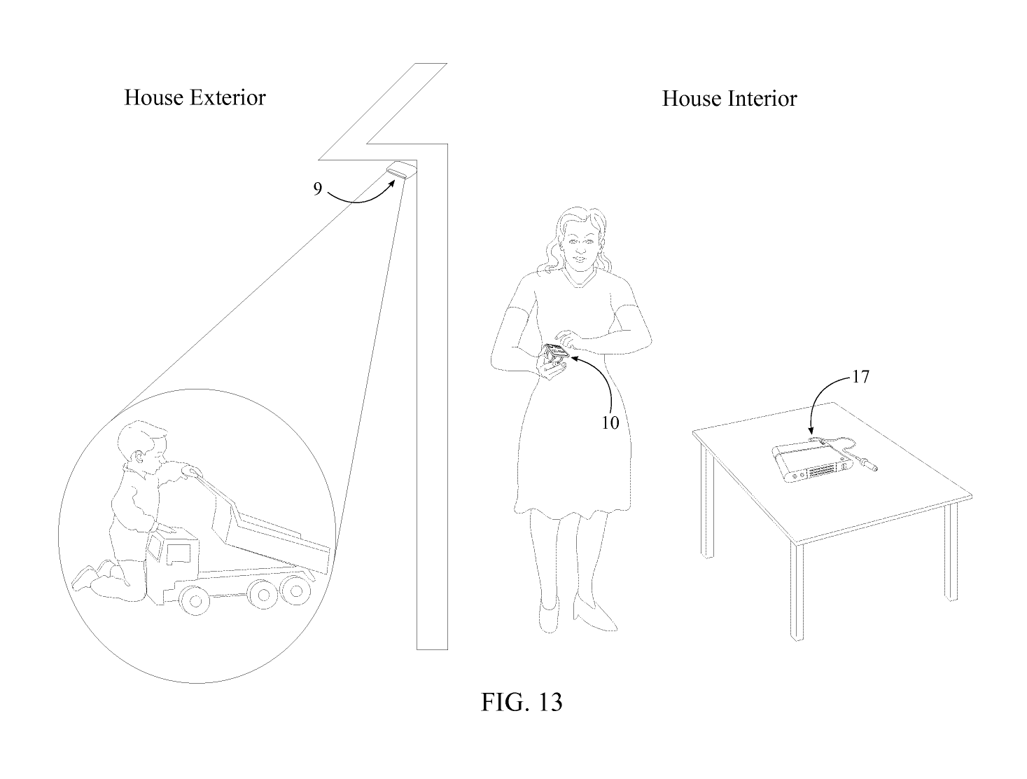

In order to properly use the present invention, the following process flow is followed. However, it should be noted that other similar process flows can also be followed to achieve the desired functional purposes of the present invention. First, the internal visual recording unit 1 is placed in the interior of the vehicle. Preferably, the internal visual recording unit 1 is attached to the rearview mirror such that events in the immediate vicinity of the driver can be recorded. The external visual recording unit 9 is attached on the exterior of the vehicle such that events in the immediate vicinity of the vehicle can be recorded. By utilizing the remote control 10, both the internal visual recording unit 1 and the external visual recording unit 9 can be controlled. For user convenience, the remote control 10 is attached to the steering wheel of the vehicle in the preferred embodiment of the present invention. All data recorded by the internal visual recording unit 1 and the external visual recording unit 9 is stored securely in the remote data storage device 17. When utilizing the present invention, the external visual recording unit 9 can be removed since it is attached via the external detachable mount 27. After detaching the external visual recording unit 9 and the remote control 10, the present invention can be used even outside a vehicle as illustrated in FIG. 12 and FIG. 13. In such instances, the external visual recording unit 9 can be attached to a different surface with the external detachable mount 27.

Although the invention has been explained in relation to its preferred embodiment, it is to be understood that many other possible modifications and variations can be made without departing from the spirit and scope of the invention as hereinafter claimed.

1. A driver protection camera system for recording audio and video comprises:
an internal visual recording unit;
an external visual recording unit;
a remote control;
a remote data storage device;
the remote control comprises an activation switch and a microphone;
the internal visual recording unit and the external visual recording unit each comprise a camera, a unit housing, a motion detection unit, and a unit beacon locator;
the remote control being communicably coupled to the internal visual recording unit, the external visual recording unit, and the remote data storage device;
the internal visual recording unit and the external visual recording unit being communicably coupled to the remote data storage device;
the internal visual recording unit and the external visual recording unit each further comprise a processing unit and a wireless transceiver;
the camera being electronically connected to the processing unit;
the wireless transceiver being electronically connected to the processing unit;
the motion detection unit being electronically connected to the processing unit;
the unit beacon locator being electronically connected to the processing unit; and
the camera, the wireless transceiver, the motion detection unit, the unit beacon locator, and the processing unit being positioned within the unit housing.

2. (canceled)

3. The driver protection camera system for recording audio and video as claimed in claim 1 comprises:
the camera comprises a wide view lens; and
the wide view lens being integrated into the unit housing.

4. The driver protection camera system for recording audio and video as claimed in claim 1 comprises:
an internal detachable mount; and
the internal visual recording unit being adjacently connected to the internal detachable mount.

5. The driver protection camera system for recording audio and video as claimed in claim 4, wherein the internal detachable mount is a clamp.

6. The driver protection camera system for recording audio and video as claimed in claim 1 comprises:
an external detachable mount; and
the external visual recording unit being adjacently connected to the external detachable mount.

7. The driver protection camera system for recording audio and video as claimed in claim 6, wherein the external detachable mount being made of a magnetic material.

8. The driver protection camera system for recording audio and video as claimed in claim 1 comprises:
a C-shaped bracket; and
the remote control being adjacently connected to the C-shaped bracket.

9. The driver protection camera system for recording audio and video as claimed in claim 1 comprises:
the remote control further comprises a processing unit, a controller housing, a wireless transceiver, and a recording indicator light;
the activation switch being electronically connected to the processing unit;
the microphone being electronically connected to the processing unit;
the wireless transceiver being electronically connected to the processing unit;
the recording indicator light being electronically connected to the processing unit;
the processing unit, the wireless transceiver, and the microphone being positioned within the controller housing; and
the activation switch and the recording indicator light being positioned onto the controller housing.

10. The driver protection camera system for recording audio and video as claimed in claim 1 comprises:
the remote data storage device comprises a data storage medium, a plurality of audio/video ports, a plurality of data transfer ports, a processing unit, a wireless transceiver, a data storage beacon locator, and a storage system housing;
the data storage medium being electronically connected to the processing unit;
the plurality of audio/video ports being electronically connected to the processing unit;
the plurality of data transfer ports being electronically connected to the processing unit;
the data storage beacon locator being electronically connected to the processing unit;
the wireless transceiver being electronically connected to the processing unit;
the data storage medium and the processing unit being positioned within the storage system housing;
the storage system beacon locator and the wireless data transceiver being positioned within the storage system housing; and
the plurality of audio/video ports and the plurality of data transfer ports being positioned onto the storage system housing.

11. A driver protection camera system for recording audio and video comprises:
an internal visual recording unit;
an external visual recording unit;
a remote control;
a remote data storage device;
the remote control comprises an activation switch and a microphone;
the internal visual recording unit and the external visual recording unit each comprise a camera, a unit housing, a motion detection unit, and a unit beacon locator;
the remote control being communicably coupled to the internal visual recording unit, the external visual recording unit, and the remote data storage device;
the internal visual recording unit and the external visual recording unit being communicably coupled to the remote data storage device;
the internal visual recording unit and the external visual recording unit each further comprise a processing unit and a wireless transceiver;
the camera being electronically connected to the processing unit;
the wireless transceiver being electronically connected to the processing unit;
the motion detection unit being electronically connected to the processing unit;
the unit beacon locator being electronically connected to the processing unit;
the camera, the wireless transceiver, the motion detection unit, the unit beacon locator, and the processing unit being positioned within the unit housing;
the remote data storage device comprises a data storage medium, a plurality of audio/video ports, a plurality of data transfer ports, a processing unit, a wireless transceiver, a data storage beacon locator, and a storage system housing;
the data storage medium being electronically connected to the processing unit;
the plurality of audio/video ports being electronically connected to the processing unit;
the plurality of data transfer ports being electronically connected to the processing unit;
the data storage beacon locator being electronically connected to the processing unit;
the wireless transceiver being electronically connected to the processing unit;
the data storage medium and the processing unit being positioned within the storage system housing;
the storage system beacon locator and the wireless data transceiver being positioned within the storage system housing; and
the plurality of audio/video ports and the plurality of data transfer ports being positioned onto the storage system housing.

12. The driver protection camera system for recording audio and video as claimed in claim 11 comprises:
the camera comprises a wide view lens; and
the wide view lens being integrated into the unit housing.

13. The driver protection camera system for recording audio and video as claimed in claim 11 comprises:
an internal detachable mount; and
the internal visual recording unit being adjacently connected to the internal detachable mount.

14. The driver protection camera system for recording audio and video as claimed in claim 13, wherein the internal detachable mount is a clamp.

15. The driver protection camera system for recording audio and video as claimed in claim 11 comprises:
an external detachable mount; and
the external visual recording unit being adjacently connected to the external detachable mount.

16. The driver protection camera system for recording audio and video as claimed in claim 11, wherein the external detachable mount being made of a magnetic material.

17. The driver protection camera system for recording audio and video as claimed in claim 11 comprises:
a C-shaped bracket; and
the remote control being adjacently connected to the C-shaped bracket.

18. The driver protection camera system for recording audio and video as claimed in claim 11 comprises:
the remote control further comprises a processing unit, a controller housing, a wireless transceiver, and a recording indicator light;
the activation switch being electronically connected to the processing unit;
the microphone being electronically connected to the processing unit;
the wireless transceiver being electronically connected to the processing unit;
the recording indicator light being electronically connected to the processing unit;
the processing unit, the wireless transceiver, and the microphone being positioned within the controller housing; and
the activation switch and the recording indicator light being positioned onto the controller housing.

19. (canceled)
